(19) United States
(12) Patent Application Publication
(10) Pub. No.: US 2026/0342693 A1
(43) Pub. Date: Oct. 29, 2026

(54) ESTIMATION APPARATUS, LEARNING APPARATUS, ESTIMATION METHOD, LEARNING METHOD, AND PROGRAM

(71) Applicant: NTT, Inc., Tokyo (JP)

(72) Inventors: Kenichi KAWAMURA, Tokyo (JP); Motoharu SASAKI, Tokyo (JP); Naoki SHIBUYA, Tokyo (JP); Takatsune MORIYAMA, Tokyo (JP)

(73) Assignee: NIPPON TELEGRAPH AND TELEPHONE CORPORATION, Tokyo (JP)

(21) Appl. No.: 19/119,694

(22) PCT Filed: Oct. 27, 2022
(86) PCT No.: PCT/JP2022/040251

§ 371 Date: Apr. 9, 2025

(51) Int. Cl. H04L 41/5025; H04L 41/16

(52) U.S. Cl. CPC H04L 41/5025; H04L 41/16

(57) ABSTRACT

An estimation apparatus that estimates a range of changes in communication quality at a certain position, the estimation apparatus comprising: an input unit that inputs position information indicating the position; and an estimation unit that estimates one or more statistical values related to the communication quality from the position information by using a learned model, and estimates the range of changes on the basis of the one or more statistical values.

### TECHNICAL FIELD

The present invention relates to a technique for estimating radio communication quality.

### BACKGROUND ART

In applications of remote control, remote monitoring and the like of a mobile object such as a vehicle or a robot, generally remote communication is carried out between a server of a center and a terminal provided in the mobile object at a site by radio communication. In addition, since the mobile object moves, radio communication quality of remote communication is required to be of high availability in consideration of safety. It is thought to be that it is effective to estimate (predict) whether radio communication quality can be stably used at a destination of a mobile object, and to perform processing such as lowering a moving speed in advance or lowering a rate of video transmission so as not to cause instantaneous interruption of video when there is a risk. Therefore, it is important to estimate the communication quality at the destination.

As an example of a method for estimating radio communication quality at the destination, there is a technique for estimating communication quality at a destination in advance on the basis of a history indicating a relationship between a position of a mobile object and communication quality in the past (refer to NPL 1). According to the technique disclosed in NPL 1, there has been proposed a technique for estimating the communication quality of the throughput as a median value or a mean value by machine learning or the like by using measurement values (actual values) of the past communication quality.

### CITATION LIST

### Non-Patent Literature

NPL 1: Kawamura, et al. “Optimal selection of multi-radio network in automatic operation of agricultural machines based on prediction of radio communication quality,” IEICE General Conference, Mar., 2021.

### SUMMARY OF INVENTION

### Technical Problem

However, in a radio communication of a mobile object whose position changes, changes in the radio wave environment or fluctuations in radio communication quality are significant in some cases. Thus, the estimation value of the communication quality as a median value or a mean value as in the prior art is not enough to accurately determine whether desired communication quality can be continuously satisfied or not.

The present invention has been made in view of the above-mentioned points, and it is an object of the present invention to estimate, as accurately as possible, whether or not desired communication quality can be continuously satisfied, even in the case of radio communication by a mobile object whose position changes.

### Solution to Problem

According to the disclosed technique, provided is an estimation apparatus that estimates a range of changes in communication quality in a certain position, the estimation apparatus comprising:
an input unit that inputs position information indicating the position; and
an estimation unit that estimates one or more statistical values related to the communication quality from the position information by using a learned model, and estimates the range of changes based on the one or more statistical values.

### Advantageous Effects of Invention

According to the disclosed technique, even in the case of radio communication by a mobile object whose position changes, it is possible to estimate, as accurately as possible, whether or not desired communication quality can be continuously satisfied.

### BRIEF DESCRIPTION OF DRAWINGS

FIG. 1 is a configuration diagram of a learning apparatus 100 according to an embodiment of the present invention.

FIG. 2 is a flowchart for describing an operation of the learning apparatus 100.

FIG. 3 is a configuration diagram of an estimation apparatus 200 according to an embodiment of the present invention.

FIG. 4 is a diagram showing a configuration example of an estimation unit 220.

FIG. 5 is a flowchart for explaining an operation of the estimation apparatus 200.

FIG. 6 is a diagram showing an example of an upper limit value and a lower limit value.

FIG. 7 is a diagram showing a hardware configuration example of each of the apparatuses.

### DESCRIPTION OF EMBODIMENTS

Hereinafter, an embodiment of the present invention (the present embodiment) will be described with reference to the drawings. The embodiment to be described below is merely an example, and an embodiment to which the present invention is applied is not limited to the following embodiment.

In the following description, it is assumed that “communication quality” refers to the quality of radio communication, but the technique according to the present invention is applicable to communication quality of communication performed by wire instead of wirelessly. In the following description, it is assumed that the communication quality refers to the quality of the communication when a terminal performs the radio communication, unless otherwise specified. Further, the “communication quality” may be referred to as “quality.”

It is assumed that the “terminal” moves. The “terminal” may be a smart phone or the like owned by a person, or a communication device mounted on a mobile object such as a drone, an automobile, or a robot, and a mobile object itself such as a drone, an automobile, or a robot may be referred to as a “terminal.”

In the following description, a learning apparatus 100 and an estimation apparatus 200 will be described, but the learning apparatus 100 and the estimation apparatus 200 may be identical.

The “communication quality” used in the following may refer to any of reception power, throughput, delay, jitter, and packet loss, or the “communication quality” may refer to another quality. Further, a “model” described below may be referred to as a “learning apparatus.”

In the following description, a normal distribution is used as a distribution of communication quality assumed when estimating a range of changes in communication quality, but this is an example. A distribution other than the normal distribution may be used as a distribution of communication quality assumed when estimating a range of changes in communication quality.

### Overview of Embodiment

In the present embodiment, the learning apparatus 100 uses measurement data of past communication quality measured at various points (positions), to learn, by means of machine learning, models outputting statistical values of communication quality (specifically, mean value and variance) on the basis of position information indicating a position. The estimation apparatus 200 outputs an upper limit value and a lower limit value of communication quality falling within a desired distribution range, from the position information, by using the learned models learned by the learning apparatus 100.

Hereinafter, the configurations and operations of the learning apparatus 100 and the estimation apparatus 200 will be described in detail.

### Configuration of Learning Apparatus 100

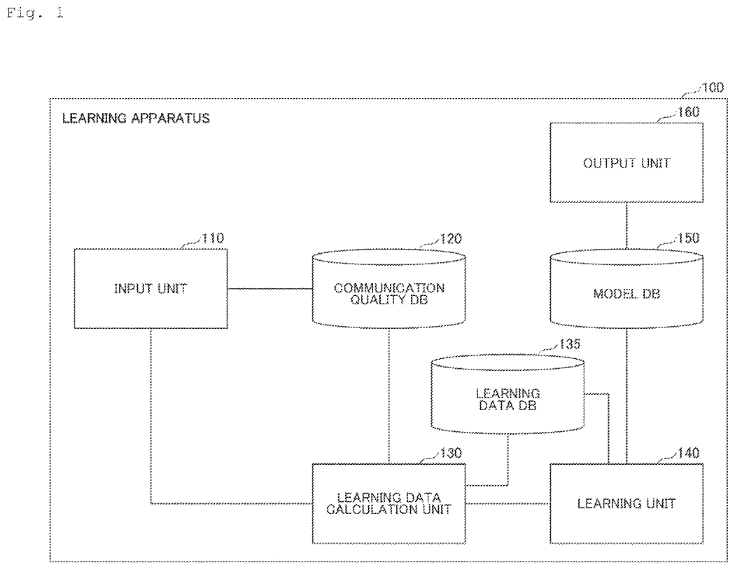

FIG. 1 shows a configuration example of the learning apparatus 100. As shown in FIG. 1, the learning apparatus 100 includes an input unit 110, a communication quality DB (database) 120, a learning data calculation unit 130, a learning data DB 135, a learning unit 140, a model DB 150, and an output unit 160. The communication quality DB 120 may be provided outside of the learning apparatus 100. The outline of the functions of each unit is as follows.

The input unit 110 inputs past history information of communication quality, having position information and measurement values (measurement data) of communication quality at the position. The input history information is stored in the communication quality DB 120.

The learning data calculation unit 130 generates (calculates) learning data from the history information stored in the communication quality DB 120, and stores the generated learning data in the learning data DB 135.

The learning unit 140 learns a model by machine learning using learning data stored in the learning data DB 135. Although models in the present embodiment are not limited to specific types, it is assumed that, for example, neural network models are used.

Models learned by the learning unit 140 are stored in the model DB 150. Models stored in the model DB 150 are, specifically, for example, functions and weight parameters.

Models stored in the model DB 150 are output from the output unit 160 and input into the estimation apparatus 200.

Note that, as described above, the learning apparatus 100 and the estimation apparatus 200 may be identical. For example, the learning apparatus 100 may include the functions of the estimation apparatus 200. In such a case, the learning apparatus 100 can use a learned model to output a range (an upper limit value, a lower limit value) of changes in communication quality with respect to an inquiry (position information or the like).

### Operation of Learning Apparatus 100

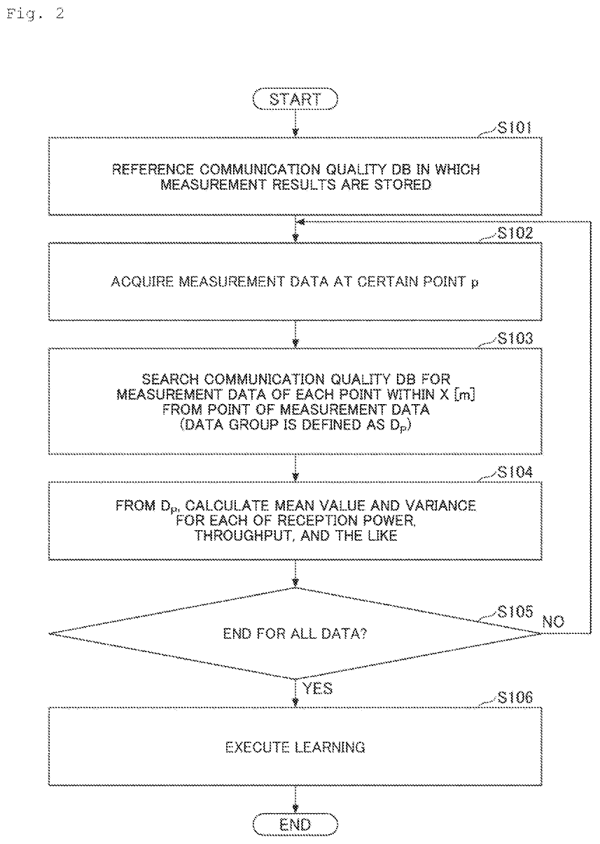

Operations of the learning apparatus 100 will be described in detail with reference to the flowchart of FIG. 2. Here, it is assumed that history information (measurement data) of communication quality measured at various points has already been stored in the communication quality DB 120.

### S101 and S102

In S101, the learning data calculation unit 130 references the communication quality DB 120. In S102, the learning data calculation unit 130 acquires measurement data of communication quality of a certain point p from the communication quality DB 120.

The measurement data at the certain point p is measurement data measured by a terminal when the terminal is located at the point p. However, the present invention is not limited thereto, and for example, the measurement data at the certain point p may be measurement data measured by another device communicating with the terminal when the terminal is located at the point p.

The measurement data acquired here include, for example, position information (e.g., latitude, longitude) of the point p, and a value of communication quality (e.g., reception power, throughput, delay, jitter, packet loss). Note that the “value of communication quality” may be referred to as “communication quality.”

For example, when “reception power, throughput, and delay” are taken as communication quality, calculation and learning of statistical values (mean value, variance, and the like) described below are executed for each of the reception power, throughput, and delay.

### S103

In S103, the learning data calculation unit 130 searches the communication quality DB 120 for measurement data of each point within X [m] from the point p of the measurement data acquired in S102 and acquires the measurement data. The acquired data group is defined as Dp.

X may be determined in advance or may be input from the input unit 110. Each piece of the measurement data includes communication quality obtained at a measurement point.

### S104

In S104, the learning data calculation unit 130 calculates a mean value and a variance for each communication quality from Dₚ. As to the variance, either a sample variance or an unbiased variance may be calculated, or both may be calculated. The calculated mean value and variance are stored in the learning data DB 135 together with the position information (p).

The mean value and the variance are examples of one or more statistical values. For example, when either the mean value or the variance is known (or when a specific value is used as an assumption), only one of the mean value and the variance need be calculated.

### S105

The learning data calculation unit 130 repeatedly executes S102 to S104 while changing the point p until processing for all the target measurement data is completed (until the result of S105 becomes Y).

### S106

The learning unit 140 learns a model about each communication quality by using “position information, mean value, and variance” stored in the learning data DB 135. The learned models are stored in the model DB 150.

In the present embodiment, a model for outputting a mean value (referred to as a mean value model) with position information as an input and a model for outputting a variance with position information as an input (referred to as a variance model), are learned.

For example, as to the mean value model, learning is performed by inputting position information and adjusting parameters so that an error between an output from the model and a mean value of correct answers is minimized. The same applies to the other model.

As described above, learning of the mean value model and the variance model is an example. Instead of the variance model, a model for outputting a standard deviation may be learned.

Further, a model for outputting both the mean value and the variance may be learned from the position information. Further, a model may be learned which outputs an upper limit value and a lower limit value in which the probability that the value enters the normal distribution is P by inputting the position information and a desired distribution range P[%] to be described later.

### Estimation Apparatus 200

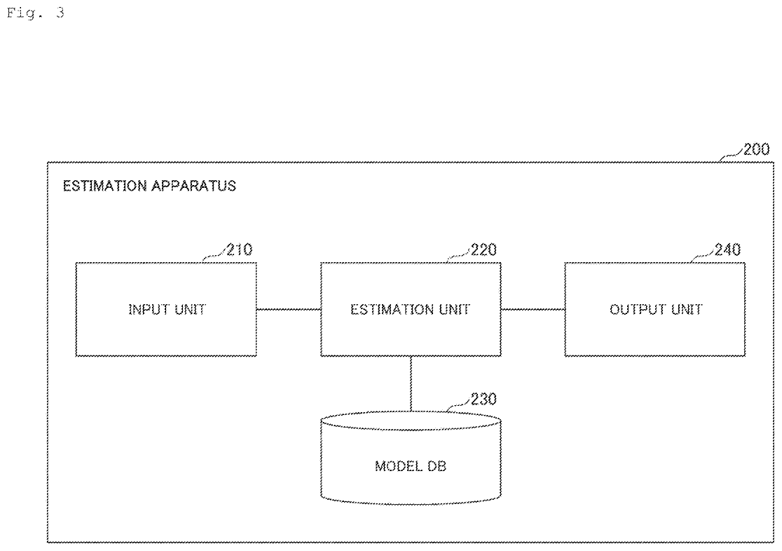

Next, the estimation apparatus 200 will be described. FIG. 3 is a configuration diagram of the estimation apparatus 200. As shown in FIG. 3, the estimation apparatus 200 includes an input unit 210, an estimation unit 220, a model DB 230, and an output unit 240.

The model DB 230 stores a learned model learned by the learning device 100.

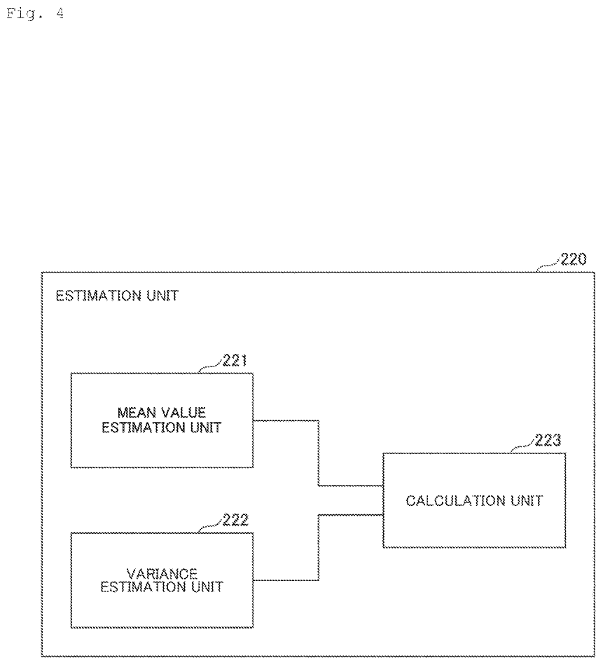

FIG. 4 shows an example of the internal configuration of the estimation unit 220 assuming that the learning apparatus 100 learns a mean value model and a variance model.

As shown in FIG. 4, the estimation unit 220 includes a mean value estimation unit 221, a variance estimation unit 222, and a calculation unit 223. The mean value estimation unit 221 reads a mean value model from the model DB 230, and estimates a mean value from the position information by using the mean value model.

The variance estimation unit 222 reads a variance model from the model DB 230, and estimates a variance from the position information by using the variance model.

The calculation unit 223 calculates an upper limit value and a lower limit value in which the probability of the value entering the normal distribution having the estimated mean value and variance is P[%].

### Operations of Estimation Apparatus 200

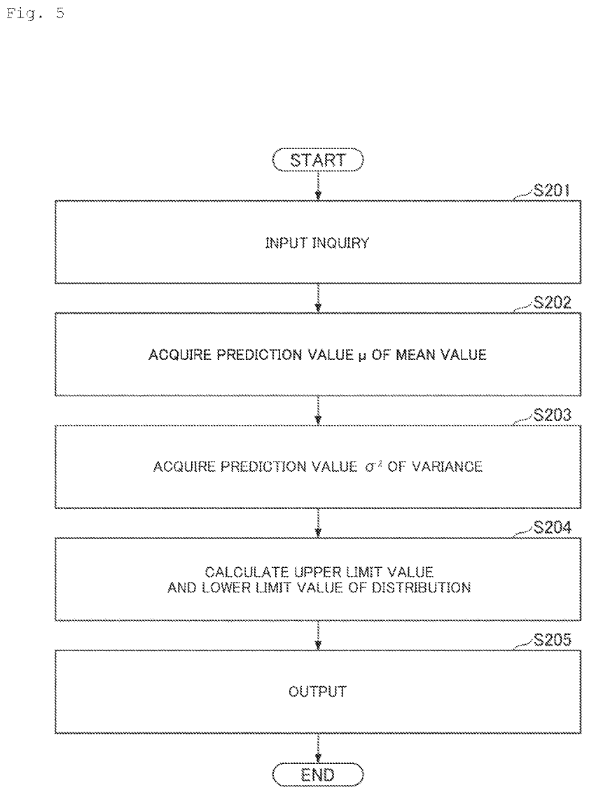

Operations of the estimation apparatus 200 having the configuration shown in FIGS. 3 and 4 will be described with reference to a flowchart shown in FIG. 5. Here, it is assumed that “communication quality” is a certain kind of communication quality (e.g., throughput). In order to know the range of changes in a certain type of communication quality, input may be made in S201.

### S201

In S201, position information (e.g., latitude and longitude), in which a range of changes in communication quality (specifically, an upper limit value and a lower limit value) is to be estimated, and a desired distribution range P [%] are input from the input unit 210. The input information may be received as an inquiry from a terminal connected to the estimation apparatus 200 via a network, for example.

The position information is input into the mean value estimation unit 221 and the variance estimation unit 222 of the estimation unit 220, respectively. The desired distribution range P[%] is input into the calculation unit 223 of the estimation unit 220. The distribution range P[%] may be set in advance in the calculation unit 223 as a predetermined value.

### S202

In S202, the mean value estimation unit 221 acquires a prediction value u of a mean value from the position information by using the mean value model. The prediction value μ of the mean value is input into the calculation unit 223.

### S203

In S203, the variance estimation unit 222 acquires a prediction value of of a variance from the position information by using the variance model. The prediction value σ² of the variance is input into the calculation unit 223.

### S204

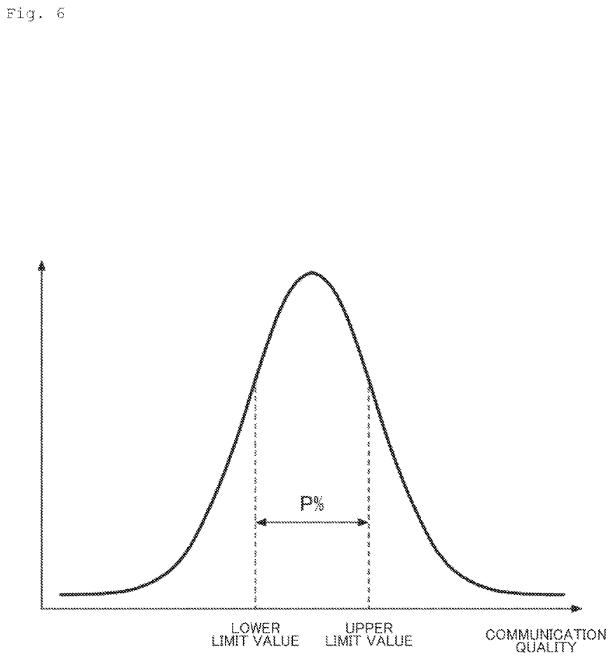

In S204, from the prediction value μ, the prediction value σ², and the desired distribution range P[%], the calculation unit 223 calculates the upper limit value and the lower limit value of the distribution in which the probability of the value entering the normal distribution is P[%] when assuming the normal distribution of μ and σ². The upper limit value may be referred to as high-order quality, and the lower limit value may be referred to as low-order quality. An image of P[%], the upper limit value, and the lower limit value is shown in FIG. 6. Although FIG. 6 shows a range in which the mean value is the center, this is an example. For example, the upper limit value and the lower limit value in a range deviated to a side of the quality indicating the quality to be better (or worse) than the mean value may be obtained depending on the use.

### S205

The calculated upper limit value and lower limit value are delivered to the output unit 240 and output from the output unit 240. For example, the output unit 240 includes a display, and the upper limit value and the lower limit value are displayed on the display. The output unit 240 may transmit the upper limit value and the lower limit value to the terminal, which is the inquiry source, via the network.

The estimation apparatus 200 may hold the upper limit value and the lower limit value without outputting the upper limit value and the lower limit value. The held upper limit value and lower limit value are read from an external device as necessary.

### Hardware Configuration Example

Any of the apparatuses (the learning apparatus 100 and the estimation apparatus 200) described in the present embodiment can be realized, for example, by causing a computer to execute a program. This computer may be a physical computer or a virtual machine on the cloud.

That is, the apparatuses can be realized by executing programs corresponding to processing performed by the apparatuses using hardware resources such as a CPU and a memory contained in a computer. The above programs can be recorded on a computer-readable recording medium (such as a portable memory) and can be stored or distributed. Further, the above programs can also be provided through a network such as the Internet or e-mail.

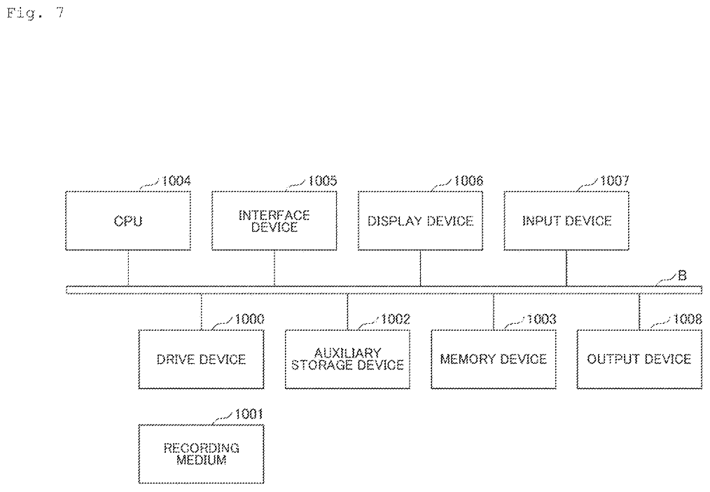

FIG. 7 is a diagram showing an example of a hardware configuration of the computer. The computer of FIG. 7 includes a drive device 1000, an auxiliary storage device 1002, a memory device 1003, a CPU 1004, an interface device 1005, a display device 1006, an input device 1007, an output device 1008, and the like which are connected to each other via a bus BS. The computer may further include a GPU.

A program for realizing processing in the computer is provided by, for example, a recording medium 1001 such as a CD-ROM or a memory card. When the recording medium 1001 having the program stored therein is set in the drive device 1000, the program is installed in the auxiliary storage device 1002 from the recording medium 1001 via the drive device 1000. However, the program does not necessarily have to be installed from the recording medium 1001, and may be downloaded from another computer via a network. The auxiliary storage device 1002 stores the installed program and also stores necessary files, data, and the like.

The memory device 1003 reads and stores the program from the auxiliary storage device 1002 when there is an instruction to start the program. The CPU 1004 realizes functions related to the device according to the program stored in the memory device 1003. The interface device 1005 is used as an interface for connection to a network or the like. The display device 1006 displays a graphical user interface (GUI) or the like according to a program. The input device 1007 is configured from a keyboard, a mouse, buttons, a touch panel, or the like, and is used to input various operation instructions. The output device 1008 outputs a calculation result.

### Effects of Embodiment

According to the technique described in the present embodiment, it is possible to estimate the range of changes in radio communication quality, and it is possible to determine the use of radio access in consideration of the lower limit, the upper limit, and the probability of quality estimation based on position information or the like. That is, even in the case of radio communication by a mobile object whose position changes, it is possible to estimate, as accurately as possible, whether or not desired communication quality can be continuously satisfied.

Regarding the above embodiment, the following clauses are further disclosed.

### CLAUSES

### Clause 1

An estimation apparatus that estimates a range of changes in communication quality at a certain position, the estimation apparatus comprising:
a memory; and
at least one processor connected to the memory,
wherein
the processor
inputs position information indicating the position, and estimates one or more statistical values related to the communication quality from the position information by using a learned model, and estimates the range of changes based on the one or more statistical values.

### Clause 2

The estimation apparatus according to clause 1, wherein the one or more statistical values are a mean value and a variance, and the processor estimates the range of changes by using a distribution having the mean value and the variance.

### Clause 3

The estimation apparatus according to clause 2, wherein the processor estimates an upper limit value and a lower limit value corresponding to a desired range in the distribution, as the range of changes.

### Clause 4

A learning apparatus that learns a model used to estimate a range of changes in communication quality at a certain position, the learning apparatus comprising:
a memory; and
at least one processor connected to the memory,
wherein
the processor
calculates one or more statistical values for each of positions, from measurement data of communication quality at each of the positions, and
learns the model by using position information of each of the positions and the one or more statistical values as learning data.

### Clause 5

An estimation method executed by an estimation apparatus that estimates a range of changes in communication quality at a certain position, the estimation method comprising the steps of:
inputting position information indicating the position; and estimating one or more statistical values related to the communication quality from the position information by using a learned model, and estimating the range of changes based on the one or more statistical values.

### Clause 6

A learning method executed by a learning apparatus that learns a model used to estimate a range of changes in communication quality at a certain position, the learning method comprising the steps of:
calculating one or more statistical values for each of positions, from measurement data of communication quality at each of the positions; and
learning the model by using position information of each of the positions and the one or more statistical values as learning data.

### Clause 7

A non-transitory storage medium storing a program for causing a computer to function as each unit of the estimation apparatus described in any one of clauses 1 to 3.

### Clause 8

A non-transitory storage medium storing a program for causing a computer to function as each unit of the learning apparatus described in clause 4.

Although the present embodiment has been described above, the present invention is not limited to such a specific embodiment, and various modifications and changes can be made within the scope of the gist of the present invention described in the claims.

### REFERENCE SIGNS LIST

100 Learning apparatus
110 Input unit
120 Communication quality DB
130 Learning data calculation unit
135 Learning data DB
140 Learning unit
150 Model DB
160 Output unit
200 Estimation apparatus
210 Input unit
220 Estimation unit
221 Mean value estimation unit
222 Variance estimation unit
223 Calculation unit
230 Model DB
240 Output unit
1000 Drive device
1001 Recording medium
1002 Auxiliary storage device
1003 Memory device
1004 CPU
1005 Interface device
1006 Display device
1007 Input device
1008 Output device

1. An estimation apparatus that estimates a range of changes in communication quality at a certain position, the estimation apparatus comprising:
a processor; and
a memory storing program instructions that cause the processor to:
input position information indicating the position; and
estimate one or more statistical values related to the communication quality, from the position information, by using a learned model, and estimate the range of changes based on the one or more statistical values.

2. The estimation apparatus according to claim 1, wherein the one or more statistical values are a mean value and a variance, and the program instructions cause the processor to estimate the range of changes by using a distribution having the mean value and the variance.

3. The estimation apparatus according to claim 2, wherein the program instructions cause the processor to estimate an upper limit value and a lower limit value corresponding to a desired range in the distribution, as the range of changes.

4. A learning apparatus that learns a model used to estimate a range of changes in communication quality at a certain position, the learning apparatus comprising:
a processor; and
a memory storing program instructions that cause the processor to:
calculate one or more statistical values for each of a plurality of positions, from measurement data of communication quality at each of the positions; and
learn the model by using position information of each of the positions and the one or more statistical values as learning data.

5. An estimation method executed by an estimation apparatus that estimates a range of changes in communication quality at a certain position, the estimation method comprising:
inputting position information indicating the position; and
estimating one or more statistical values related to the communication quality, from the position information, by using a learned model, and estimating the range of changes based on the one or more statistical values.

6. (canceled)

7. A non-transitory computer-readable recording medium having computer-readable instructions stored thereon, which when executed, causes a computer including a memory and a processor to function as the estimation apparatus according to claim 1.

8. A non-transitory computer-readable recording medium having computer-readable instructions stored thereon, which when executed, causes a computer including a memory and a processor to function as the learning apparatus according to claim 4.
